(19) United States
(12) Patent Application Publication
(10) Pub. No.: US 2004/0194585 A1
(43) Pub. Date: Oct. 7, 2004

(54) Coaxial cable thumb socket

(76) Inventor: Margaret Annette Clark, Pittsford, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/406,305

(22) Filed: Apr. 3, 2003

(51) Int. Cl. B25B 13/00

(52) U.S. Cl. 81/124.2

(57) ABSTRACT

A rotatable coaxial cable thumb socket for use with an elongated coaxial cable. The thumb socket includes a sleeve shaped body mounted over the coaxial cable in proximity to a rotatable end nut associated with the cable. The sleeve shaped body further exhibits a hexagonal cross sectional shaped interior surface which exhibits an inward taper extending in an axial direction towards the rotatable end nut and to enhance frictional engagement with the nut. Upon axial translation of the body, over the end nut, the hexagonal cross sectional shaped interior surfaces contact associated exterior surfaces of the end nut, and such that the socket body is rotated to facilitate both loosening and tightening of the end not relative to a threaded socket receptor.

### BACKGROUND OF THE INVENTION

1. Field of the Invention

The present invention relates generally to wrench or socket devices for application to a fixed rotatable end nut associated with a coaxial cable. More specifically, the present invention discloses a rotatable coaxial cable thumb socket, incorporated into an axially translatable sleeve fitted over the coaxial cable, and which facilitates the loosening and retightening of the rotatable end nut relative to a male threaded socket coax socket receptor.

2. Description of the Prior Art

The prior art is well documented with various examples of coupling and decoupling devices for use with elongated cables and the like. Some coax cable fittings of varying designs include Pitschi, U.S. Pat. No. 3,970,355; Toma, U.S. Pat. No. 5,607,325; and Sucht et al., U.S. Pat. No. 5,011,432.

U.S. Pat. No. 3,963,321, issued to Burger, teaches a connector arrangement for coax cables which includes a connector sleeve having a conical cavity which receives and secures that portion of the coaxial cable from which the outer protection sheath has been stripped. A collar tightly surrounds a section of the protective sheath and the connector sleeve further includes a shoulder setting off the collar from the conical cavity. An insert is provided having an external thread at one end for connection to another component and is provided with an internal bore having a diameter equal to the outer diameter of the cable insulation or spacers.

U.S. Pat. No. 4,464,001, issued to Collins, teaches an electrical connector assembly/coupling nut and in which mating shells are provided with end faces on dielectric inserts and a coupling nut rotatably mounted to a first of the shells. The coupling nut includes a substantially “U” shaped passageway sized to receive a coupling pin disposed on the second shell. The passageway further forms an integral cantilevered latch spring to assist in coupling and decoupling of the first shell.

### SUMMARY OF THE PRESENT INVENTION

The present invention is a rotatable and coaxial thumb socket for use with an elongated coaxial cable, incorporated into an axially translatable sleeve which is fitted over the coaxial cable, and which facilitates the loosening and retightening of a rotatable end nut associated with the cable and relative to a male threaded socket coax socket receptor. Additionally, the coaxial thumb socket provides both a secure and electrically insulating engagement with the associated end nut.

The thumb socket in a first embodiment includes a sleeve shaped body mounted over the coaxial cable and so that it is axially slidable therewith when not in rotatably engaging contact with the end nut portion of the cable. The sleeve shaped body is preferably constructed of a plastic, nylon or other suitable electrically insulating material and exhibits a hexagonal cross sectional shaped interior surface which, upon axial translation of the body over the end nut, aligns with a hex-head configuration exhibited by the rotatable nut.

In a further preferred variant, the interiorly defined hexagonal surfaces exhibit an inward taper in an axial direction towards the end nut and so that, upon slidable engagement of the thumb socket, an increased degree of frictional engagement is established therebetween. Additional variants include the sleeve shaped body exhibiting an axially extending and split portion and such that the body can be compressed to reduce its circumferential area and increase the engaging forces applied to the exterior sides of the hex nut. Also, the exterior surface of the sleeve shaped body can further exhibit a knurled or other suitable pattern to facilitate rotative engagement of the body about the end nut.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a first perspective view of the coaxial cable thumb socket according to the present invention;

FIG. 2 is a second perspective view of the coaxial cable thumb socket, illustrated in engagement with an associated rotatable end nut and a male threaded socket coax socket receptor;

FIG. 3 is a cutaway end view, taken along line 3-3 of FIG. 1, and showing the hexagonal configuration of the cable thumb socket;

FIG. 4 is a perspective view of the coaxial cable thumb socket according to a second preferred embodiment of the present invention and illustrating an axially extending split along its length; and

FIG. 5 is an axial cutaway view of the coaxial cable thumb socket and illustrating the inside taper which extends in a direction toward the rotatable end nut.

### DETAILED DESCRIPTION OF THE PREFERRED EMBODIMENTS

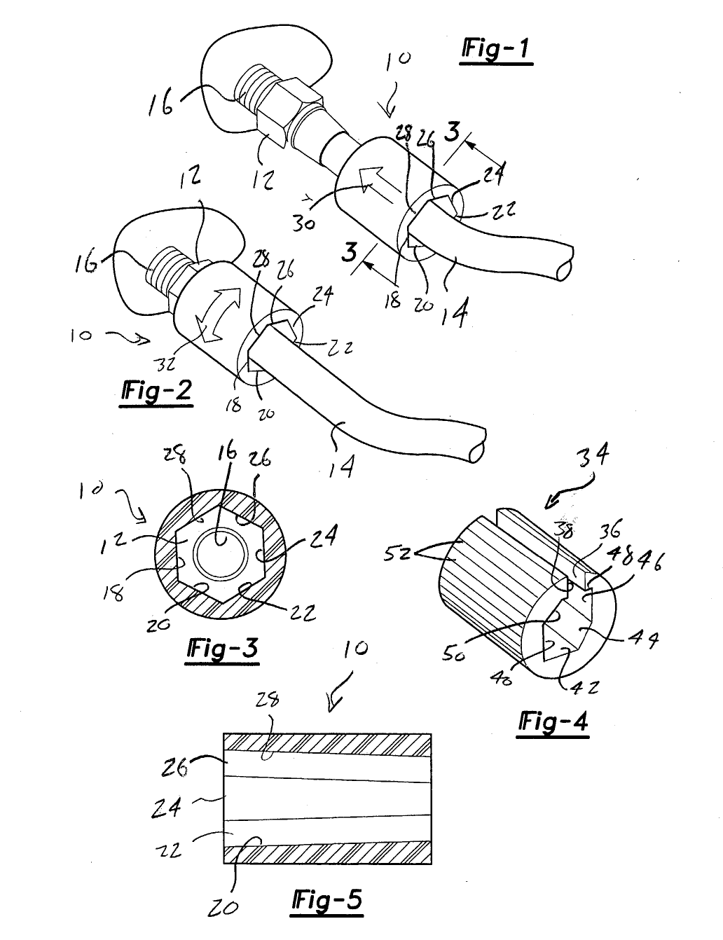

Referring now to FIGS. 1 and 2, a coaxial cable thumb socket is illustrated at 10 according to a preferred embodiment of the present invention. As previously described, the cable socket 10 facilitates the loosening and retightening of a rotatable end nut 12 associated with an elongated coaxial cable 14 and relative to a male threaded coax socket receptor 16 to which the rotatable end nut 12 is rotatably engaged.

As again is best illustrated in FIGS. 1 and 2, the socket 10 is constructed of a substantially sleeve shaped and elongated body which is mounted in freely slidable fashion over the coax cable 14. In a preferred variant, the socket exhibits a substantially cylindrical shaped exterior and is constructed of a suitable material, such as a nylon or plastic, such further providing a degree of electrically insulating protection to the rotatable nut end 12 of the coax cable and when in slidably engaged fashion thereover.

As is also illustrated in reference to FIG. 3, the sleeve shaped body 10 exhibits a hexagonal cross sectional shaped interior surface, further exhibited by interconnected sides 18, 20, 22, 24, 26, and 28 and which, upon axial alignment over the end nut 12, interengage with associated exterior facing hex surfaces of the end nut 12. As is further illustrated in the axial cutaway view of FIG. 5, the interiorly facing surfaces of the thumb socket body further exhibit an inward taper in an axial direction towards the rotatable end nut 12 (see in particular for sides 20 and 28). The purpose behind the arrangement and configuration of the inwardly tapered sides is to establish a greater degree of frictional engagement, between the inwardly facing sides 10-28 of the body 10 and the associated exterior facing and likewise hexagonal surfaces of the end nut 12, and upon axially displacing the body 10 in engaging fashion over the nut 12.

In use, the thumb socket body 10 is translated in the direction referenced by arrow 30 in FIG. 1, along a specified axial distance of the cable 14 and into its desired engaging contact with the end nut 12. The thumb socket body 10 is then rotated in one of two rotational directions (see further arrow 32 in FIG. 2) such that the end nut 12 is rotated in unison and in one of either a loosening or tightening direction relative to the threaded socket receptor. As further previously indicated, it is desirable to leave the socket body 10 in engagement over the end nut 12, following attachment of the end nut to the male threaded coax socket receptor 16, and to provide an extra degree of electrically insulating protection to the coax socket/end nut connection.

Referring finally to FIG. 4, a further preferred embodiment is illustrated at 34 of the coaxial cable thumb socket according to the present invention and by which an axially extending split portion is defined along the sleeve shaped body. In particular, the split portion is further exhibited by spaced apart and inwardly facing side surfaces 36 and 38 and which, upon positioning of the socket 34 in engaging contact over the end nut 12, enables the body 34 to be compressed and to thereby reduce its interior circumferential area to thereby increase the frictional and rotatable engagement over the faces of the end nut. The remaining features of the socket 34, including its hexagonal faced interior configuration (see interconnected sides 40, 42, 44, 46, 48 and 50) is repeated, as is the provision of a knurled pattern 52 on its exterior facing surface and to facilitate gripping by the individual.

Having described my invention, additional preferred embodiments will become apparent to those skilled in the art to which it pertains, and without deviating from the scope of the appended claims:

I claim:

1. A rotatable coaxial cable thumb socket for use with an elongated coaxial cable, comprising:
a sleeve shaped body mounted over the coaxial cable in proximity to a rotatable end nut associated with the cable; and
wherein at least one interiorly defined surface associated with said sleeve shaped body contacts an associated surface of the end nut such that said socket body is rotated to facilitate both loosening and tightening of said end nut relative to a threaded socket receptor.

2. The coaxial cable thumb socket as described in claim 1, said sleeve shaped body further comprising a hexagonal cross sectional shaped interior surface which, upon axial translation of said body over the end nut, aligns with a hex-head configuration exhibited by the rotatable nut.

3. The coaxial cable thumb socket as described in claim 1, said interiorly defined surface further comprising an inward taper extending in an axial direction towards the rotatable end nut.

4. The coaxial cable thumb socket as described in claim 1, further comprising an axially extending split portion along said sleeve shaped body.

5. The coaxial cable thumb socket as described in claim 1, further comprising said sleeve shaped body exhibiting a specified shape and size and being constructed of at least a plastic or nylon material.

6. The coaxial cable thumb socket as described in claim 1, said sleeve shaped body having a specified shape and size and further comprising a substantially elongated and cylindrical shaped exterior.

7. The coaxial cable thumb socket as described in claim 1, said sleeve shaped body having a specified shape and size and further comprising a knurled exterior surface.

8. A rotatable coaxial cable thumb socket for use with an elongated coaxial cable, comprising:
a sleeve shaped body mounted over the coaxial cable in proximity to a rotatable end nut associated with the cable, said sleeve shaped body further including a hexagonal cross sectional shaped interior surface; and
wherein, upon axial translation of said body over the end nut, said hexagonal cross sectional shaped interior surfaces contact associated exterior surfaces of the end nut and said socket body is rotated to facilitate both loosening and tightening of the end nut relative to a threaded socket receptor.

9. A rotatable coaxial cable thumb socket for use with an elongated coaxial cable, comprising:
a sleeve shaped body mounted over the coaxial cable in proximity to a rotatable end nut associated with the cable, said sleeve shaped body being constructed of an electrically insulating material and further including a hexagonal cross sectional shaped interior surface which further exhibits an inward taper extending in an axial direction towards the rotatable end nut; and
wherein, upon axial translation of said body over the end nut, said hexagonal cross sectional shaped interior surfaces contact associated exterior surfaces of the end nut and said socket body is rotated to facilitate both loosening and tightening of the end nut relative to a threaded socket receptor.
